(19) United States
(12) Patent Application Publication
(10) Pub. No.: US 2004/0110468 A1
(43) Pub. Date: Jun. 10, 2004

(54) Wireless network with presentation and media layers for broadcast satellite and cable services

(76) Inventor: Stephen G. Perlman, Palo Alto, CA (US)

Correspondence Address: BURGESS & BEREZNAK LLP, 800 WEST EL CAMINO REAL, SUITE 180, MOUNTAIN VIEW, CA, 94040, US

(21) Appl. No.: 10/395,749

(22) Filed: Mar. 24, 2003

Related U.S. Application Data
(63) Continuation-in-part of application No. 10/315,624, filed on Dec. 10, 2002.

(51) Int. Cl. H04B 7/185; H04Q 7/20

(52) U.S. Cl. 455/13.3; 455/12.1; 455/427

(57) ABSTRACT

A wireless network includes a satellite antenna assembly with a reflector dish and at least one low-noise block converter (LNB) positioned opposite the reflector dish. A wireless transceiver transmits video and data information to one or more users located in a surrounding area. An interface unit is coupled to provide communication signals to the wireless transceiver. The unit is also configured for connection to an interactive data network so that the one or more users are provided with connectivity to the interactive data network via the wireless transceiver. It is emphasized that this abstract is provided to comply with the rules requiring an abstract that will allow a searcher or other reader to quickly ascertain the subject matter of the technical disclosure. It is submitted With the understanding that it will not be used to interpret or limit the scope or meaning of the claims. 37 CFR 1.72(b).

### RELATED APPLICATIONS

This application is a continuation-in-part application of Ser. No. 10/315,624 filed Dec. 10, 2002 entitled, “WIRELESS NETWORK PROVIDING DISTRIBUTED VIDEO/DATA SERVICES”. The present application is also related to Ser. No.______ , filed Feb. 14, 2003.

### FIELD OF THE INVENTION

The present invention relates generally to the field of transmission of digital data; more specifically, to satellite communication systems and networks for distributing video data and for providing interactive services to geographically dispersed clients.

### BACKGROUND OF THE INVENTION

Satellite communications systems have been widely deployed over the past several decades. By way of example, Direct Broadcast Satellite (DBS) services have increasingly expanded to provide a variety of video program services directly to people's homes, apartments, and offices. In a conventional direct-to-home (DTH) satellite communication system, one or more telecommunications satellites in geosynchronous orbit receive media content from a broadcast “uplink” center. The satellite then radiates microwave signal beams to send the media content across a geographical region of the planet. For example, in the case of satellite service providers like DirectTV® video programs are broadcast across a wide region of the continental United States from several satellites in geosynchronous orbit above the Earth's equator.

Subscriber homes in the U.S. typically utilize an outdoor antenna dish mounted to their roof or an exterior wall to receive the satellite-transmitted signals. A satellite receiver or set-top box within the home is connected to the antenna for acquiring the satellite carrier signal and displaying the video program content received from the satellite transmission. As is well known, the satellite receiver may include decompression, decryption, decoder, demodulation and other circuitry for converting the received signals into a format (e.g., high definition television (HDTV), standard definition television (SDTV), etc.) suitable for viewing on a display device by the subscriber. For example, for direct-to-home digital satellite carriers which conform to Digital Video Broadcast (DVB) standards, the satellite receiver is configured to receive a set of parameters that may include the polarization, symbol rate, forward error correcting (FEC) rate and frequency to acquire the satellite digital carrier. U.S. Pat. Nos. 6,473,858, 6,430,233, 6,412,112, 6,323,909, 6,205,185, and 5,742,680 describe various conventional satellite communication systems that operate in this manner.

Satellite transmissions are often grouped in channel sets, wherein each channel set spans a certain transmit band. The channel sets are typically isolated by different electromagnetic polarizations. For instance, channel sets may be transmitted with linear polarization (i.e., horizontal or vertical) or circular polarization (i.e., left-hand or right-hand). These channel sets are detected on a polarization-sensitive antenna assembly through a low-noise block converter (LNB) mounted opposite a parabolic antenna dish. The LNB may be configured, for example, to detect the horizontal or vertical polarized signals reflected from the antenna dish. The LNB connects to the satellite receiver unit or set-top box located inside the subscriber's home via a coaxial cable.

In some receiving systems two LNBs are provided to receive both channel sets so that multiple television sets within a home may view different program channels simultaneously. Examples of different satellite data receiving systems are found in U.S. Pat. Nos. 6,424,817 and 5,959,592.

One of the problems with satellite communication systems is that they generally require an unobstructed line-of-sight between the orbiting satellite and the receiving antenna dish. In the United States, for instance, satellites typically orbit above the equator and are therefore “seen” by the antenna above the southern horizon. A home in a densely populated metropolitan region, however, may have its view of the southern sky obstructed by a tall building. In other cases, apartment dwellers living in units on the north side of a building may be precluded from mounting an antenna anywhere to receive satellite transmissions from a satellite orbiting above the southern horizon.

In other cases, landlords who own apartment buildings containing multiple units may be reluctant to permit tenants to mount multiple antenna dishes on their structure or route cable wires through the exterior and interior of the building. Routing of wires is also a problem in homes, particularly when multiple televisions are to receive programming services. The line-of-sight requirement and the problem of multi-dwelling units (MDUs) have therefore limited the number of homes that can receive digital services from satellite vendors.

An additional problem that satellite vendors generally face is the difficulty of providing interactive data services to their customers. Some specialized satellite service providers offer two-way data services, but these systems require the subscriber to purchase a fairly large antenna dish (e.g., 3-5 feet wide) with increased power demands for uplink transmission to the satellite. Another drawback is the inherent latency associated with signal transmission from Earth to the orbiting satellite, and then back down to Earth. This latency can produce sluggish system performance as compared to terrestrial cable systems, for example, when the user wants to access a web page containing large amounts of content and data.

Thus, there is a pressing need for new apparatus and methods for distributing satellite services and video content to the general population on an expanded basis. There is also a need for a communication network that provides additional services, such as interactive data services, to subscribers at a competitive cost and at a high performance level.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a conceptual diagram of a satellite communication system in accordance with one embodiment of the present invention.

FIG. 2 is a perspective view of an antenna assembly according to one embodiment of the present invention.

FIG. 3 is a more detailed view of the components comprising the signal unit of the antenna assembly shown in FIG. 2.

FIG. 4 is an example showing an application of the present invention to a multi-dwelling unit.

FIG. 5 illustrates the spectrum band utilized for cable communications with the wireless transceiver in accordance with one embodiment of the present invention.

FIG. 6 depicts the type of information and signals transmitted between the network interface/satellite receiver device and antenna assembly according to one embodiment of the present invention.

FIG. 7 shows the example of FIG. 4 optionally including a mass storage repository according to another embodiment of the present invention.

FIG. 8 shows an alternative embodiment of the present invention, wherein a wireless transceiver is incorporated in a distribution box.

FIG. 9 shows an example of a wireless transceiver functioning as a free-standing repeater in accordance with an embodiment of the present invention.

FIG. 10 is an example of an antenna assembly according to another embodiment of the present invention.

FIG. 11 illustrates a wireless network that carries presentation layer content provided by a source to multiple destination devices in accordance with an embodiment of the present invention.

FIG. 12 illustrates a wireless network that seamlessly integrates Internet traffic with video content in accordance with an embodiment of the present invention.

FIG. 13 is a circuit block diagram of the basic architecture of a DBS tuner according to one embodiment of the present invention.

FIG. 14 is a circuit block diagram of the basic architecture of a cable television tuner/router in accordance with one embodiment of the present invention.

FIG. 15 is a circuit block diagram of the basic architecture of a wireless receiver in accordance with one embodiment of the present invention.

### DETAILED DESCRIPTION

The present invention is a pioneering advancement in the field of multimedia communication systems. By integrating a wireless transceiver into a satellite antenna assembly, the present invention provides, for the first time, a wireless local area network (WLAN) which both distributes a wide range of video services (digitally-encoded broadcast services, pay-per-view television, and on-demand video services, etc.) and provides two-way (i.e., interactive) data services to individuals located across a wireless coverage region.

In the following description numerous specific details are set forth, such as frequencies, circuits, configurations, etc., in order to provide a thorough understanding of the present invention. However, persons having ordinary skill in the satellite and communication arts will appreciate that these specific details may not be needed to practice the present invention. It should also be understood that the basic architecture and concepts disclosed can be extended to a variety of different implementations and applications. Therefore, the following description should not be considered as limiting the scope of the invention.

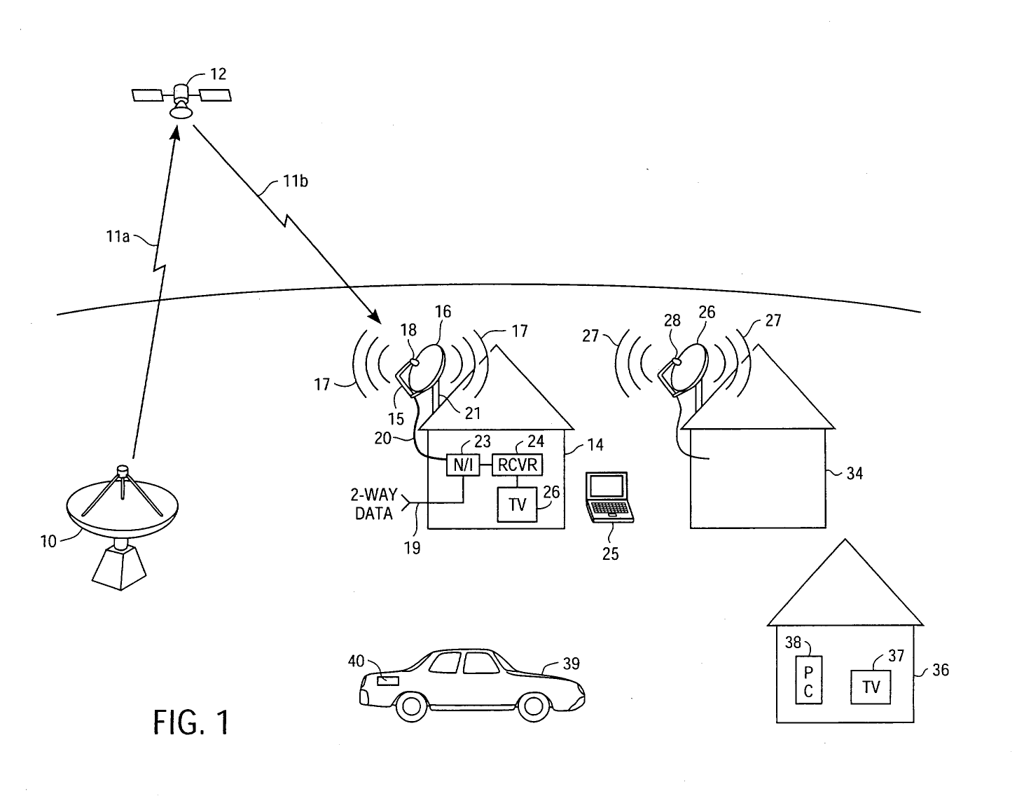

With reference to FIG. 1, a conceptual diagram of a satellite communication system in accordance with the present invention is shown comprising a telecommunications satellite 12 positioned in a fixed, geosynchronous orbital location in the sky over the particular geographical region of the Earth. Satellite 12 utilizes standard solar panels to generate power for the satellite's resources which includes one or more transponders that provide telecommunication links (i.e., “uplinks” and “downlinks”) to Earth-based stations and receivers.

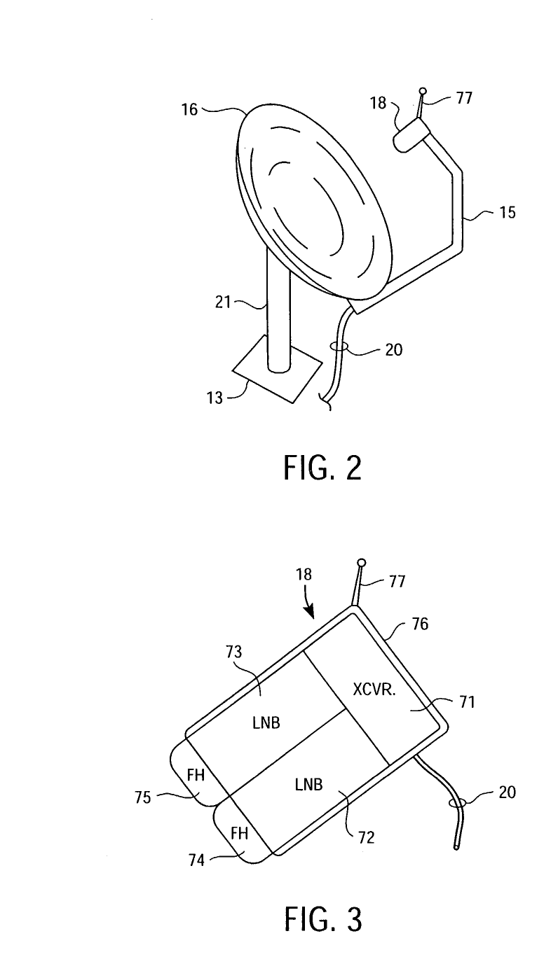

For example, FIG. 1 shows a large antenna 10 that broadcasts video programs from an uplink center to satellite 12. This uplink signal is represented by arrow 11a. Satellite 12 transmits the broadcast signal (e.g., downlink 11b) across a coverage region of the Earth, where it may be received at a home 14 equipped with an outdoor antenna assembly coupled to electronics for displaying the video programs. The antenna assembly, which is also shown in FIG. 2, includes a support 21 attached to a parabolic or concave reflector dish 16, which is aimed to the location in the sky where satellite 12 is positioned in geosynchronous orbit above the earth. Support 21 may include a base plate 13 to facilitate mounting of the antenna assembly to the exterior (e.g., roof) of house 14. An arm 15, attached to either dish 16 or support 21, extends to position a signal unit 18 at a focal point of the reflector dish 16. An antenna 77 for wireless transmissions is also shown attached to unit 18. Unit 18 converts the electromagnetic radiation reflected from dish 16 into electrical signals carried by one or more conductors 20 to a network interface unit 23 or satellite receiver 24 within home 14. Receiver 24, for example, converts the satellite transmission signals into a format for display on television 26.

With reference to FIG. 3, there is shown an exemplary embodiment of signal unit 18 in accordance with the present invention comprising a pair of low-noise block converters (LNBs) 72 & 73 and a wireless transceiver 71 mounted in a case or housing 76. Wireless transceiver 71 has an associated antenna 77 to effectuate wireless transmissions. Feed horns 74 and 75 associated with LNBs 72 & 73, respectively, protrude from a side of housing 76 that is positioned nearest to reflector dish 16. Alternatively, the signal unit 18 may utilize a single feed horn coupled to one or more LNBs. Other embodiments may include multiple transceivers, each having its own associated wireless antenna. For instance, an alternative embodiment may comprise a pair of LNBs with an associated pair of wireless transceivers, each having its own wireless antenna.

In this example, LNBs 72 & 73 may be configured to receive horizontally and vertically polarized satellite transmission signals. Cable 20 connects with the LNBs and transceiver 71. (It should be understood that within the context of this disclosure, the term “cable” is used to refer to one or more wires and that such wires may comprise coaxial wires of a type known as RG-6, or a similar type.)

It is appreciated that in other embodiments unit 18 may comprise a single LNB and a wireless transceiver. In still other embodiments, unit 18 may include four or more LNBs and one or more wireless transceivers mounted together.

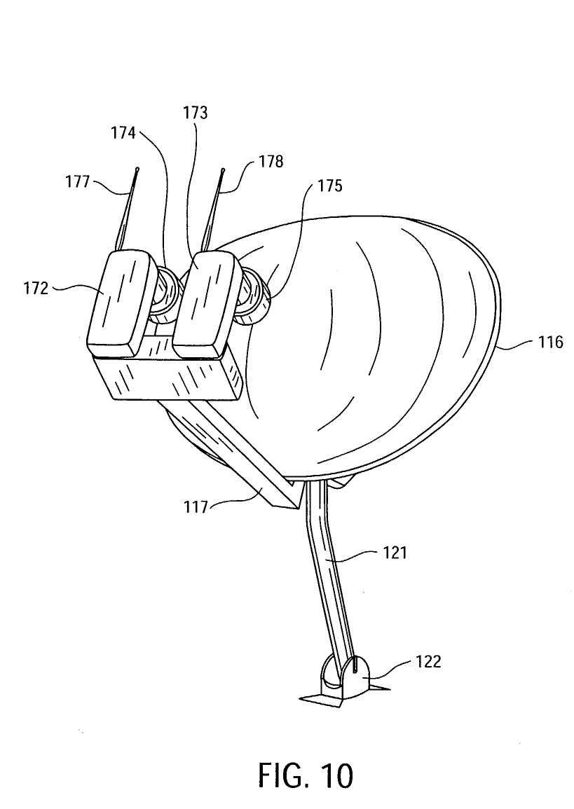

FIG. 10 shows another exemplary embodiment of an antenna assembly in accordance with the present invention comprising side-by-side LNBs 172 & 173 mounted at the end of arm 115 attached to reflector dish 116. A pair of wireless transceivers (not shown) associated with LNBs 172 & 173 are coupled to antennas 177 & 178, respectively affixed to LNBs 172 & 173. Feed horns 174 and 175 respectively attached to LNBs 172 & 173 are shown positioned to receive the satellite transmission signal reflected from dish 116. Support member 121 attaches to reflector dish 116 at one end, and to a bracket 122 at the opposite end. Bracket 122 may include screw holes or other conventional means for mounting the antenna assembly to a permanent fixture of building, e.g., a wall, roof, etc. Support member 21 and bracket 122 may also include adjustment apparatus for properly aiming reflector dish 116 at an orbiting broadcast satellite positioned at a certain point in the sky.

According to one embodiment of the present invention, wireless transceiver 71 operates in compliance with IEEE specification 802.11a, 802.11b, 802.11g, etc., to provide high-speed networking and communication capability to computers, televisions, and other devices compatibly equipped to receive such wireless signals. Other embodiments may operate in compliance with variant specifications that are compatible with IEEE specification 802.11a, 802.11b, or 802.11g, and which provide for wireless transmissions at high-bandwidth video data rates (e.g., about 2 Mbps or greater). For the purposes of the present application, IEEE specification 802.11a, 802.11b, 802.11g, and Industrial, Scientific, and Medical (ISM) band networking protocols are denoted as “802.11x”. Other non-ISM bands wireless network protocols could be utilized as well. Transceiver 71 facilitates network connectivity to users located within a surrounding range, allowing them to receive satellite broadcast programs, pay-per-view services, on-demand video, Internet access, and other interactive data services, thus obviating the need for a wired connection to individual users.

In the example of FIG. 1, transceiver 71 operates over the license-free 5 GHz band (e.g., 5725 MHz to 5850 MHz) to provide upwards of 54 Mbps of bandwidth in good transmission conditions. IEEE specification 802.11a allows for a high-speed wireless transmission of raw data at indoor distances of up to several hundred feet and outdoor distances of up to ten miles, depending on impediments, materials, and line-of-sight. 802.11a has twelve channels (eight in the low part of the band for indoor use and four in the upper for outdoor use) which do not overlap, allowing for dense installations. According to the present invention, individual users may receive transmissions from transceiver 71 using hardware equipment available from a number of vendors. For example, Proxim, Inc. manufactures and sells the Harmony 802.11a PCI card that provides wireless broadband networking at a data rate of 54 Mbps.

In another embodiment, transceiver 71 operates in compliance with IEEE specification 802.11g over the license-free 2.46 GHz band.

As shown in FIG. 1, wireless signals 17 may be transmitted from unit 18 of the antenna assembly mounted on house 14 to a nearby laptop computer 25 installed with a PC card or a PCI card that is 802.11x compliant. Similar equipment may be installed into slots of a personal computer 38 or a television 37 to provide connectivity to network services in a house 36 that is located within the neighboring range of the wireless transceiver, despite the fact that house 36 does not have a satellite antenna dish or is not otherwise wired to receive such services. This means, for example, that someone may access their electronic mail from any location within the full extent of the wireless network since the transmission signals pass easily through walls and glass.

In the example of FIG. 1, house 36 may be located outside of the signal range of wireless transmission signals 17, but within the range of the wireless signals 27 from the transceiver mounted in unit 28 of antenna assembly 26 on top of a neighboring house 34. In such a case, the transceiver within unit 28 may function as a repeater or hub for house-to-house transmissions; that is, to relay the media content and interactive services provided at home 14 to users at home 36 and elsewhere. Through the use of transceivers 71 functioning as repeaters, content and two-way data services may be distributed to end users located at considerable distances from the original service connection source. In other words, a neighborhood of antenna assemblies that include wireless transceivers can be used to create a network that provides distributed video program and interactive data connectivity. Homes installed with an antenna assembly according to the present invention may still act as a house-to-house repeater for the neighborhood as part of a “roof-hopping” scheme, even though they may not have an immediate need for wireless communications, Later on, those homes may simply add the appropriate hardware (e.g., wireless communication card, network interface box, etc.) to take advantage of the additional services such as interactive data provided by wireless connectivity.

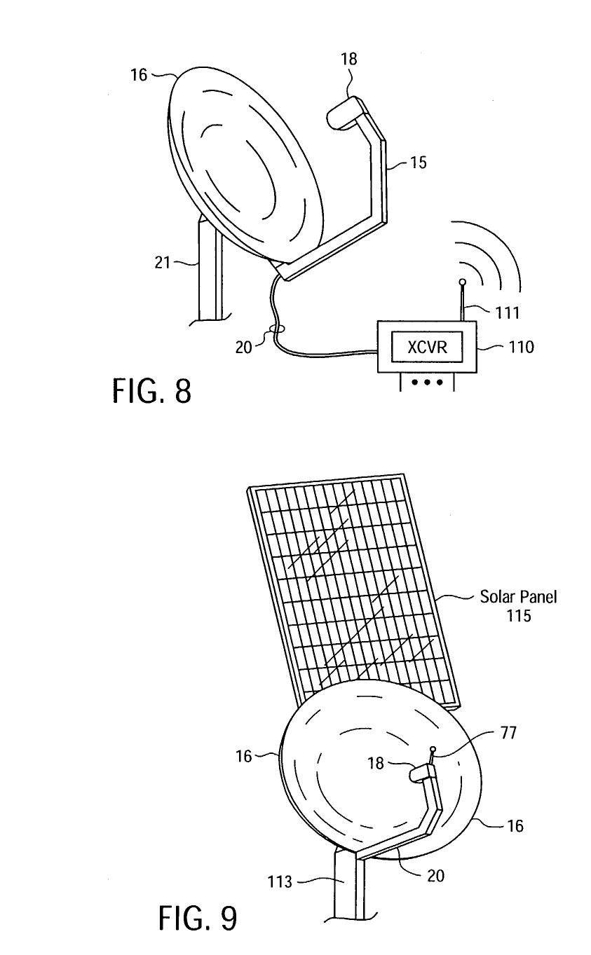

It is appreciated that wireless transceiver 71 need not be physically located on or inside of signal unit 18. In FIG. 8, for example, a wireless transceiver connected to wireless antenna 111 is incorporated into a distribution box 110. Distribution box 110 may splice into cable 20 at any point, and therefore may be remotely located some distance from the antenna assembly comprising reflector 16, arm 15, and signal unit 18. In addition to providing a point for wireless transmissions, distribution box 110 may also function as a splitter or switching device for the signals carried on cable 20.

It should be further understood that according to the present invention, the individual satellite antenna assemblies need not be located on homes or other buildings; instead, they may be positioned on existing telephone poles, or mounted on other structures with dedicated, stand-alone hardware. Additionally, a plurality of stand-alone wireless transceivers that function solely as signal repeaters may be distributed in a geographic region or throughout a large building wherever power is available to provide network connectivity that extends throughout the region or area.

For example, FIG. 9 shows a free-standing antenna assembly according to one embodiment of the present invention. The antenna assembly, which includes a signal unit 18 with wireless antenna 77 positioned at the distal end of arm 15 opposite reflector 16, is mounted on a pole 113 along with an associated solar cell panel 115. Solar cell panel 115 provides power to support the 802.11x wireless transceiver operating as a repeater on an around-the-clock basis. Solar cell panel 115 may be dimensioned sufficiently large enough, and may be coupled to a storage cell battery (not shown) mounted on the pole or in back of the panel so as to provide power “24×7” to the antenna assembly based on minimum daily solar radiation averages for the particular geographic location.

In an alternative embodiment, the concave or parabolic surface of reflector 16 may incorporate an array of solar cells. For example, solar cells may cover a portion of the reflector surface to power the wireless transceiver(s) of the satellite antenna assembly, thus obviating the need for a separate solar cell panel. In another implementation, the entire surface of the satellite dish reflector is covered with solar cells to provide power to the wireless transceiver or wireless satellite tuner.

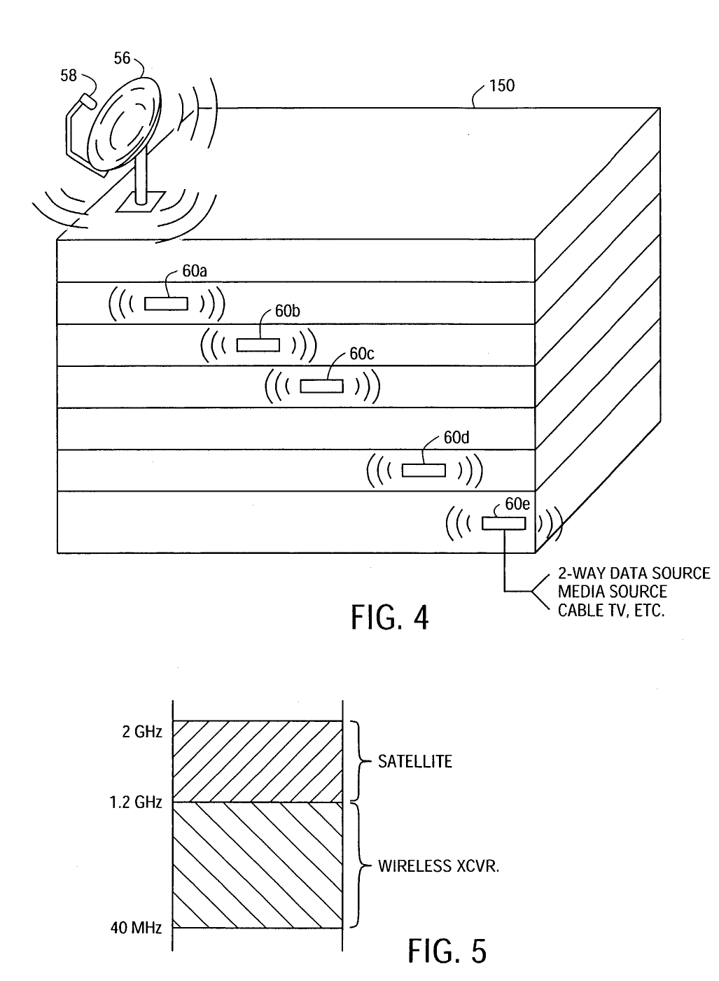

FIG. 4 shows a large apartment building 50 with a satellite antenna assembly that includes a reflector dish 56 and a wireless transceiver mounted in signal unit 58. (The electronics that provides power and command/control signals for the antenna assembly is not shown in FIG. 4 for clarity reasons.) A series of repeaters 60a-60e are located on various floors throughout the building to distribute signal transmissions to/from the transceiver of unit 58 to each of the multiple apartment units within building 50. A two-way data service connection (e.g., DSL) is provided to an 802.11x wireless transceiver/repeater 60e. Thus, subscribers located anywhere within building 50 may connect to the DSL service via this wireless transmission. Similarly, two-way data service connectivity is provided to others within the range of the transceiver of unit 58 of the antenna assembly mounted on the roof of building 50 (or to anyone in a neighboring region reached via roof-hopping signal repeating). In a metropolitan region a single satellite antenna assembly with integrated wireless transceiver can therefore distribute high bandwidth services to residents of neighboring buildings, even though those neighboring buildings may not have a satellite antenna or be otherwise wired to receive those services.

Additionally, wireless transceiver/repeater 60e may be connected to receive video content from some media source, e.g., a Digital Versatile Disk (“DVD”) player, or cable television programming. In the later case, for instance, wireless transceiver/repeater 60e may include a cable modem equipped with an 802.11x transmitter. These alternative or additional services may then be distributed in a similar manner described above.

FIG. 1 also illustrates another extension of the network provided by the present invention, wherein media content may be distributed to an 802.11x compliant receiver unit 40 installed in the trunk of an automobile 39, or other mobile vehicle. Unit 40, for instance, may include a hard disk drive to store video programs received from wireless transmission signals 17 when automobile 40 is parked, say, overnight in a garage. These programs can then be viewed by rear-seat passengers on a trip the following day.

With continued reference to the example of FIG. 1, two-way data service is shown being provided by cable 19 connected to a network interface unit 23. Cable 19 may provide a direct subscriber line (DSL) connection, for instance, which may then be distributed to subscribers in the surrounding range of wireless signals 17. Thus, according to the present invention a user of laptop computer 25, who may be located outdoors or at a nearby café, can access the Internet, watch a pay-per-view film, or receive a multitude of other multimedia services.

Alternatively, network interface unit 23 may be connected to a cable broadcast service provider (e.g., cable television) through an Ethernet or Universal Serial Bus (USB), or similar connection, thereby enabling wireless access of those cable services to subscribers within the range of the wireless network. This means that a subscriber may watch their favorite television program or a pay-per-view movie from a laptop computer or television while outdoors, in a café, or in some other building, within the wireless coverage region without the need for a direct-wired cable connection. Distribution of cable services may be implemented with a cable modem device that includes an 802.11x transmitter. It is appreciated that additional circuitry for encrypting the video and data information may also be included to thwart pirates and interlopers.

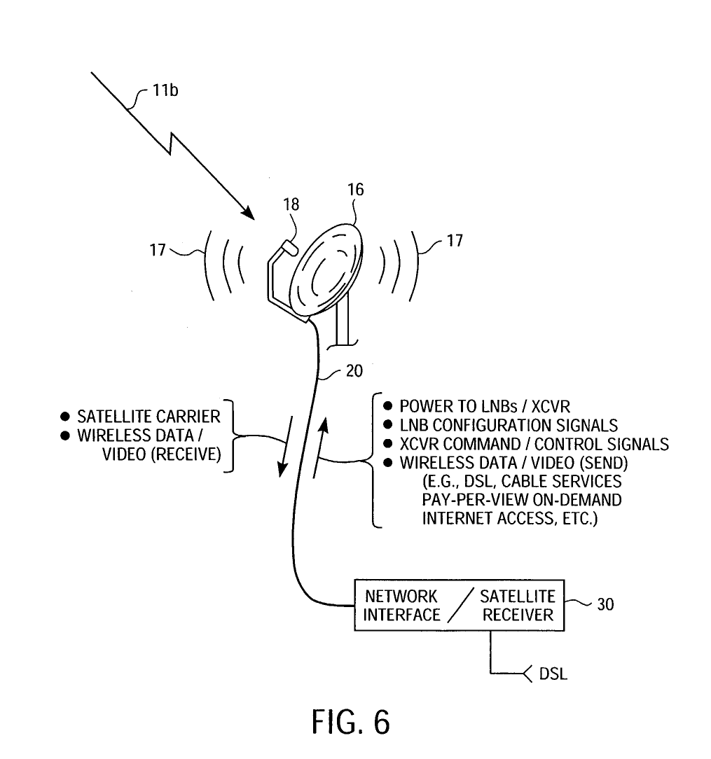

Network interface unit 23 provides power to and communicates with transceiver 71 of unit 18 via cable 20. Although the embodiment of FIG. 1 shows network interface unit 23 connected to satellite receiver 24, alternatively both devices may be integrated in to a single device 30, as shown in FIG. 6. In either case, the network interface unit communicates with the transceiver using spectrum that is not otherwise utilized in cable 20. Since satellite receivers tend to operate in the spectrum from about 1.2 GHz to about 2 GHz, the spectrum below 1.2 GHz, down to about 40 MHz, may be used for communications with the wireless transceiver. This spectrum band is illustrated in FIG. 5.

It should also be understood that although FIG. 1 shows a direct connection between satellite receiver 24 and television 26, alternatively, video services may be provided to any 802.11x compliant television (e.g., installed with an 802.11x adapter card) located within the house or surrounding wireless coverage region.

FIG. 6 depicts the type of information and signals carried by cable 20 between network interface/satellite receiver device 30 and unit 18 of the antenna assembly of the present invention. Many techniques are well known in the electronics and communications arts for transmitting such signals, such as QPSK and QAM modulation. As shown, satellite signals received by the antenna assembly are provided to device 30 via cable 20. Additionally, wireless transmissions received by transceiver 71 are coupled to device 30. Device 30 provides power to the LNBs and transceiver, LNB configurations signals, transceiver command and control signals, and wireless data via cable 20. By way of example, FIG. 6 shows device 30 having a DSL connection that may provide Internet access to users within the surrounding range of the transceiver of unit 18.

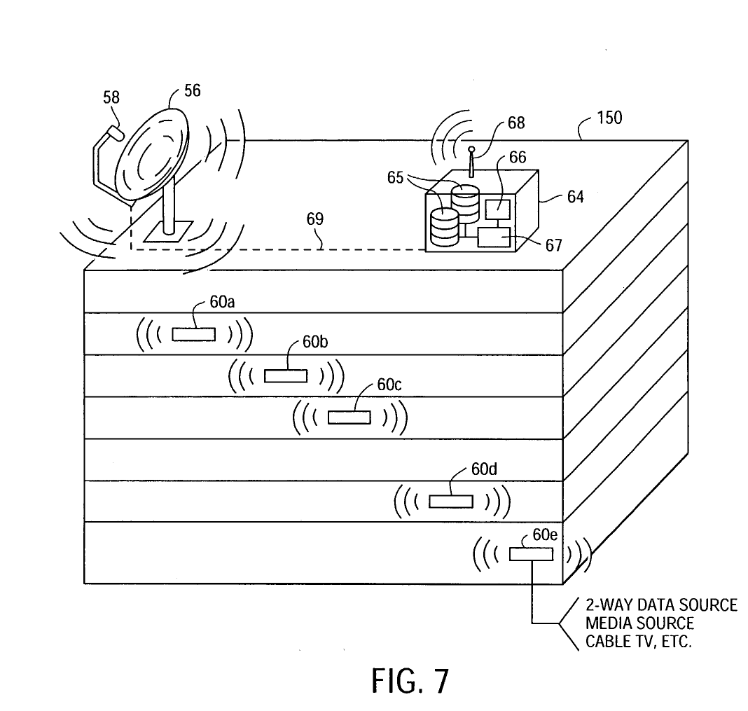

FIG. 7 illustrates the MDU example of FIG. 4, but with a specialized mass storage repository unit 64 installed on the rooftop of building 50. Repository unit 64 comprises a number of hard disk drives (HDDs) having a large total storage capacity (e.g., 10 terabytes) arranged as a RAID (“Redundant Array of Inexpensive Disks”) 65 that functions as a media library apparatus. An 802.11x compliant wireless transceiver 66 is also included in repository unit 64 along with various electronics 67 coupled to both RAID 65 and transceiver 66. Electronics 67 may comprise a microcomputer including a processor (CPU), a ROM, a RAM, etc., to control the data read/write processing by the HDDs and to control the operation of transceiver 66. Electronics 67 may also include data compression/decompression circuitry for certain video and data applications. Still other embodiments may include encryption/decryption circuitry for receiving and sending transmissions in a secure manner. The RAID 65, transceiver 66, and electronics 67 are all housed in rugged, weather-resistant enclosure providing a suitable environment for the HDDs and the other circuitry.

Repository unit 64 may communicate via wireless transmission utilizing wireless transceiver 66 connected to a wireless antenna 68 mounted on top of unit 64. Alternatively, unit 64 may be coupled with signal unit 58 via a wire connection 69 (e.g., CAT-5) to utilize the transceiver in signal unit 58 for wireless communications.

In an alternative embodiment, repository unit 64 may be attached to the satellite antenna assembly to directly utilize the wireless transceiver installed in signal unit 58.

The purpose of RAID 65 is to store recorded media content (e.g., pay-per-view movies, videos, DVDs, special event programs, etc.). This content can be accumulated over time in a “trickle feed” manner from wireless transceiver 66, which may receive content from various sources such as satellite transmissions, media players, cable television, Internet, etc. Over time, repository unit 64 may store such large volumes of video programming. Anyone having the capability to access the wireless network can pay a fee to receive a particular show, movie, or viewable program stored in repository unit 64 on an on-demand basis.

Additionally, because of the interactive capabilities of the wireless network, the subscriber or user may communicate with unit 64 to provide commands such as “pause”, “fast forward”, “rewind”, etc. Indeed, because of the large storage space available, live broadcast programs available through the WLAN described previously may be manipulated using such commands, thereby providing enhanced viewing flexibility to the user. Hard disk drive failures, which often plague in-home digital video recorders (DVRs), are not a problem because of the redundancy protection built into the RAID. Should a particular hard disk drive fail during operation, the remaining disk drive units simply take over until the repository unit can be serviced, at which time the failed drive can be replaced.

Repository unit 64 may also function as an archive storage apparatus for individuals within a local area to utilize as a storage facility for back-ups of personal data. For example, personal data such as photographs, important documents, books, articles, etc. may be transferred into a reserved space in the RAID 65. Various well-known security features may be built into repository unit 64 to maintain personal security of the backed-up data for each user.

It is also appreciated that repository unit 64 may be physically located somewhere other than on the rooftop of a building of MDUs. For instance, instead of being attached to, or nearby, a rooftop antenna assembly, repository unit 64 may be located in a top floor space, in a basement, or in a ground level facility.

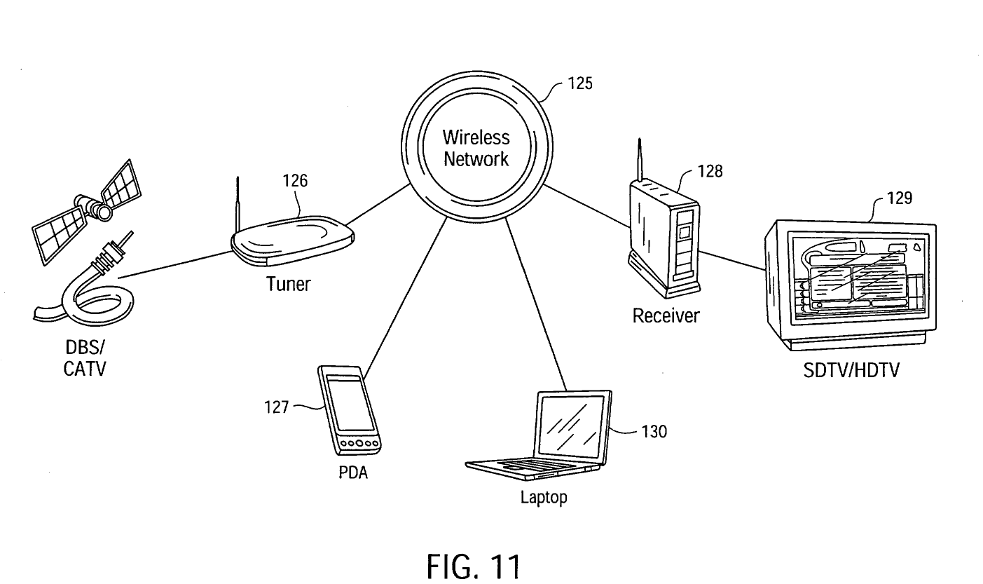

With reference now to FIG. 11, there is shown a wireless local area network (WLAN) having a topology comprising one or more access points or wireless repeaters that provides a wireless network transmission backbone 125 that carries data downstream to a variety of wireless destination devices located throughout a building, e.g., a home or office environment. The access points or repeaters of wireless network backbone 125 may include 802.11x transceivers for transmitting data upstream from the destination devices to tuner 126 or the source broadband network (e.g., Internet). The WLAN of FIG. 11 comprises a tuner 126 having a connection to a video/data source, such as cable television or satellite broadcast service provider. Tuner 126 receives the content provided by the source and sends it across backbone 125 to one or more wireless destination devices, which may include, by way of example, a PDA 127, laptop computer 130, and a wireless receiver 128 coupled to SDTV/HDTV 129. In this example, PDA 127 and laptop computer 130 are each configured with wireless transceiver cards for receiving and transmitting data across the wireless network.

Practitioners in the art will further appreciate that tuner 126 may also digitize analog video, decode it, and compress the received source data prior to transmission across the wireless network, in addition to receiving compressed digital video. In the case where compressed video is transmitted by tuner 126, receiver 128 decompresses the data as it is received. Alternatively, decompression circuitry may be incorporated into television 129 (or into an add-on box) that performs the same task. Tuner 126 may include electronics for tuning the analog channels provided by a cable service provider as well as the digital channels provided by either cable or satellite service providers. Tuner 126 may also include, or be adapted to receive, a smart card having decryption information for decrypting the satellite and/or cable signals received. In other words, the wireless network of FIG. 11 may be configured to provide a media layer that includes encryption and entitlement information.

Alternatively, encryption/decryption key information may be stored within each of the destination devices. For example, receiver 128 may include proprietary hardware/firmware or run software to exchange encryption key information or otherwise entitle receiver 128 to receive a proprietary signal. Similarly laptop 130 may securely run software that will honor network entitlements. As a subscriber to a particular satellite or cable service, a user may watch whatever content that may be received on their wireless receiver, laptop computer, PDA, etc. That is, the entitlements may be securely transferred to any destination device owned by a subscriber. Unlike conventional satellite or cable technologies in which the same encryption key is broadcast to everyone, in the embodiment of FIG. 11, the source provider transmits a unicast (i.e., point-to-point) transmission through a secure link with an encryption key specific to a particular receiver (or other destination device). Individual encryption links are provided as opposed to an overall, universally-encrypted broadcast signal.

By way of further example, after decrypting the video/data content received from a satellite or cable service provider, tuner 126 may re-encrypt that content utilizing public key encryption before wirelessly transmitting the video/data from tuner 126 to receiver 128 across backbone 125. Re-encryption thwarts interlopers or unscrupulous hackers from stealing the signal. Entitlement information, such as a list of authorized users or subscribers, may be specific to each receiver 128. In other words, tuner 126 may broadcast the encrypted cable video or satellite video signal across backbone 125, but receiver 128 will have to be registered with the satellite or cable company, or be otherwise entitled, in order for the video content to be displayed on SDTV/HDTV 129.

Still another possibility is for the cable or satellite company to grant an entitlement to tuner 126 that allows a certain limited number of data streams (e.g., three or four) to be transmitted in a particular household or office environment, regardless of the number of media destination devices that actually receive the media content. This is simply another way to restrict distribution of the media content.

It should be understood that tuner 126 of FIG. 11 may be incorporated into the antenna assembly shown in any of the previous Figures. That is, tuner 126 may be included in an antenna assembly mounted to the roof or side of a building. In such configuration, the network of the present invention enables broadband video for the entire local area. In other words, high bandwidth video content is introduced locally in the network. Internet connection data can also be inserted locally via a connection to a T1, TS3, DSL, or other similar line. Because satellite data is broadcast simultaneously across a wide geographic area, the present invention obviates the need to introduce video for each local area from the root of tree-like distribution network. Instead, the video content for the network of the present invention can be inserted locally through satellite antenna assemblies, resulting in a very robust, ad hoc network.

Once tuner 126 has tuned (and possibly decrypted) the video/data content provided by the source, it functions as a wireless server to distribute that video/data content to authorized users connected to the wireless network. In addition to video and data content, the wireless network shown in FIG. 11 may also carry presentation layer information to multiple destination devices. This allows a network operator to define how they want the user interface presented with the transmitted content to be displayed. For example, the network operator might permit a user to view movies with a certain set of presentation controls (e.g., pause, rewind, fast-forward, and so forth). Another possibility is to include controls that allow a viewer to review a synopsis of the film, or information about the actors, much like the presentation layer sometimes used for DVDs. In this manner, a DVD-like experience can be created at the front end of an entire cable or satellite network or system.

Presentation layer data may be loaded into receiver 128, which would then download the video/data transmitted by tuner 126 across backbone 125 into an internal RAM, or Flash memory, and overlay the presentation layer information on top of the media content. Thus, receiver 128 may take the various types of data it receives (video, audio, presentation, etc.) and reduce it to a particular format for display or reproduction. The particular format may include the type of user interface presented when certain types of content are displayed.

Those of ordinary skill in the art will further appreciate that the wireless network of the present invention is client or destination device independent. That is, it does not matter to the network what type of device is at the destination end receiving the transmitted media content. Video and graphics content carried on the wireless local area network of the present invention can play on multiple types of television, computers (e.g., Macintosh® or PC), different MP3 players, PDAs, digital cameras, etc. By way of example, any PC or Mac equipped with a 2.4 GHz band wireless transceiver card can detect the presence of the wireless network. Once it has detected the running wireless network, it may download a driver that contains the necessary security and protocol information for accessing the media content. Readily available software, such as RealPlayer®, QuickTime®, or Windows® MediaPlayer, may be used to play content provided through the network.

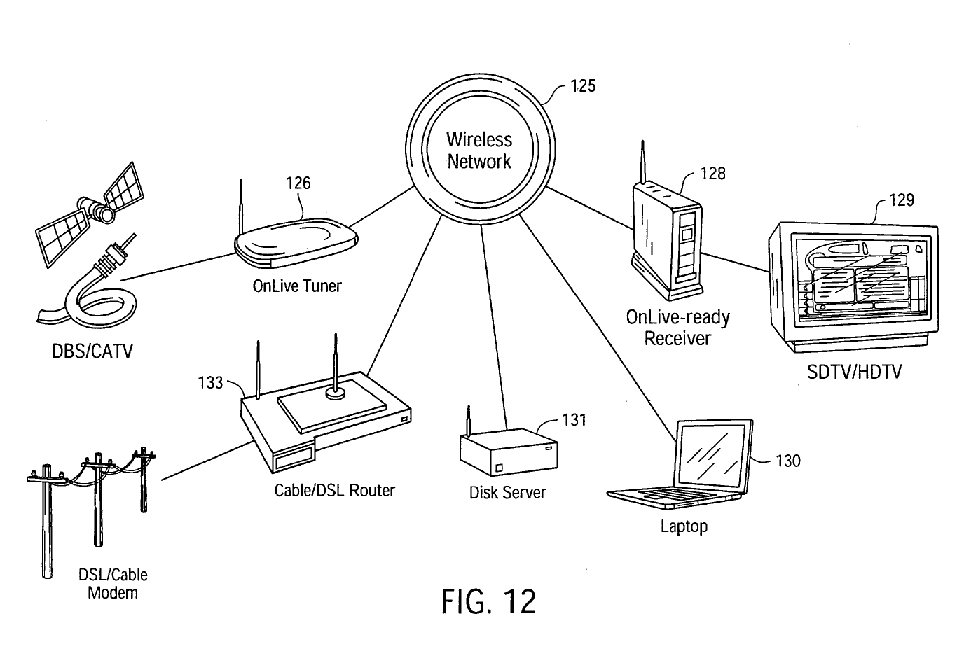

FIG. 12 illustrates a wireless network that seamlessly integrates Internet traffic with video content in accordance with another embodiment of the present invention. In addition to the devices shown in FIG. 11, the WLAN of FIG. 12 further includes a cable/DSL wireless router 133 and wireless disk server 131 coupled to backbone 125. Router 133 transmits data from a conventional cable or DSL data network across backbone 125 to the various destination devices located within the range of the WLAN. Data may also be transmitted back to the cable/DSL network from each of the destination devices via backbone 125 and router 133. The cable/DSL data integrates seamlessly with the wireless data stream so that, for example, one user may download data from the Internet while another user watches a movie or television program. In other words, tuner 126 and router 133 share the same spectrum.

Wireless disk server 131 comprises one or more disk drive units that function as a file server controlled by a microcontroller or other controller unit that may include a 802.11x transceiver, a RAM, ROM, CPU, Flash memory and other electronic devices for receiving data transmitted across backbone 125 and storing that data on a magnetic or magneto-optical recording media. Disk server 131 also functions to retrieve data previously stored for transmission on the wireless network to other requesting devices, such as laptop computer 130.

Disk server 131 provides archival storage of video and other data for the wireless local area network, and also facilitates certain presentation layer features, such as digital video recording (DVR) capabilities. For instance, video data may be stored on a magnetic disk media in server 131 for later on-demand viewing with full playback, pause, rewind, fast-forward, etc., command features. Essentially, disk server functions as a mass repository unit in the same manner as repository unit 64 previously described in conjunction with FIG. 7. Disk server 131, however, need not be a secure device. The reason why is because the WLAN shown in FIG. 12 writes/reads data to the disk storage of server 131 in encrypted form. This data can only be decrypted by a device having the proper entitlements. In other words, the same entitlements that allow a user or subscriber to watch a movie broadcast by a service provider such as the Dish® network, allow that same user to watch a previously recorded movie (stored to disk server 131) received from a Dish® transmission. Put another way, disk server 131 does not need encryption/decryption capabilities, and may comprise an ordinary disk server configured for wireless communications.

By that same token, any computer that is within the transmission range of the wireless network of the present invention can use that computer's internal disk drive for storage of video/data. Note that the archived video/data may be unusable without the proper entitlements; that is, to be able to play back a stored video program a user would need a subscription to the broadcast service, or other appropriate entitlement.

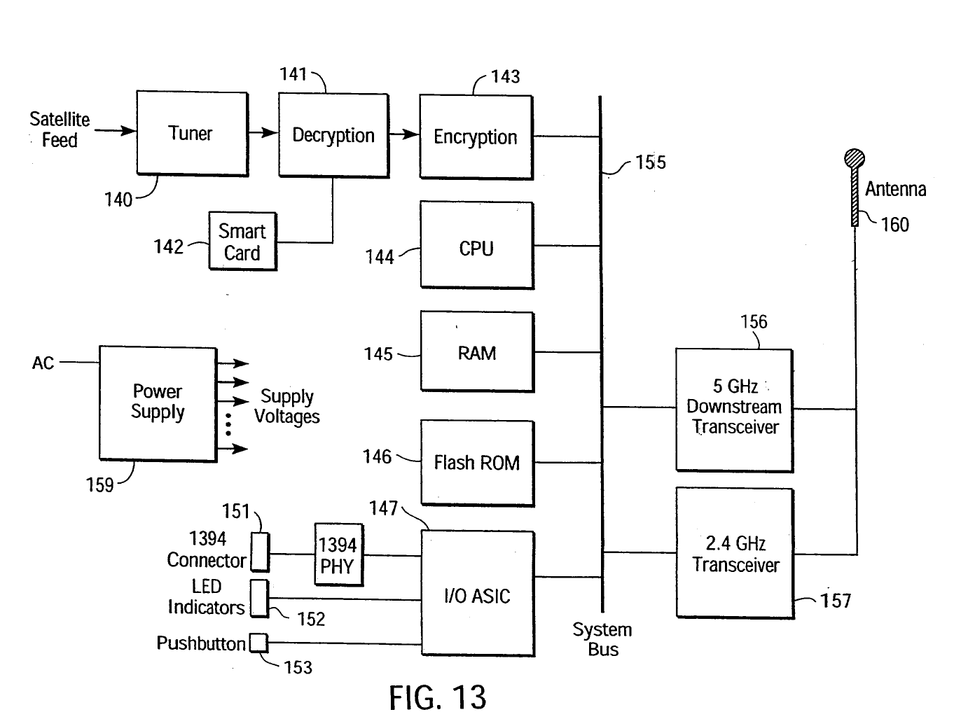

With reference now to FIG. 13, a circuit block diagram showing the architecture of a DBS tuner according to one embodiment of the present invention is shown including a CPU 144, a RAM 145, a Flash ROM 146, and I/O ASIC 147 coupled to a system bus 155. Also coupled to system bus 155 are a plurality of transceivers, which, in this particular embodiment, include a 5 GHz downstream transceiver 156, and a 2.4 GHz transceiver 157, both of which are coupled to an antenna 160. (An upstream transceiver is not needed at the source end.) Additional transceivers operating at different frequencies may also be included. In this implementation, transceiver 156 operates in compliance with IEEE specification 802.11a to run with an effective throughput of 36 Mbps for transmissions on backbone 125. Transceiver 157 is 802.11g-compliant and also runs with an effective throughput of 36 Mbps to connect to any local devices operating in the 2.4 GHz band.

CPU 144 controls the transmission of the data packets, utilizing RAM 145 for both program execution, and for buffering of the packets as they are received from the source feed before they are sent out to the downstream side, i.e., toward the destination. Flash ROM 146 may be used to hold software and encryption key information associated with secure transmissions, for example, to insure that the network users are authorized users of satellite or cable subscriber services.

In the embodiment of FIG. 13, a 1394 connector interface 151 provides a Firewire® port (coupled through a 1394 PHY physical interface) to I/O ASIC 147. Also coupled to I/O ASIC 66 is a pushbutton switch 153 and an LED indicator panel 152. Pushbutton switch 153 may be utilized in conjunction with interface 151 to authenticate the tuner for use in the network and/or for initialization. A power supply unit 159 provides a supply voltage to the internal electronic components of the tuner.

Data from the satellite feed is received by a tuner 140 and output to decryption circuitry 141, which may be configured to receive the latest encryption key information from a smart card 142. The decrypted digital stream output from block 141 is then re-encrypted by encryption circuitry 143 prior to being sent locally to destination devices. As discussed above, the re-encryption is a type of encryption appropriate for the wireless network, not one that is locked into the satellite encryption scheme.

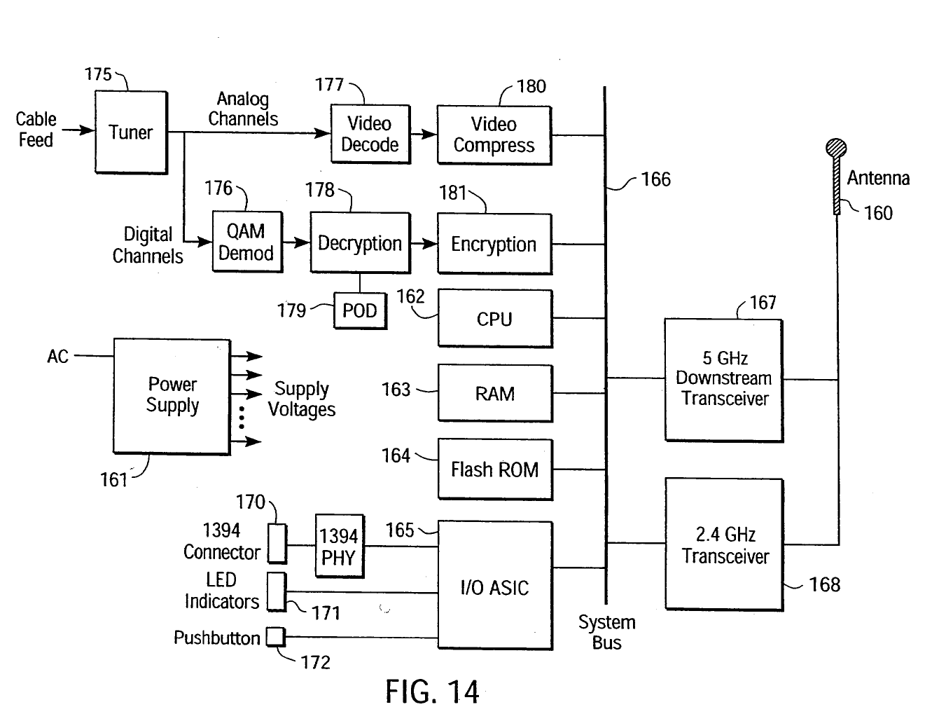

FIG. 14 is a circuit block diagram illustrating the basic architecture of a cable television tuner/router in accordance with one embodiment of the present invention. Practitioners in the art will appreciate that the architecture of FIG. 14 is somewhat more complicated due to the presence of both analog and digital signal channels. Elements 161-172 are basically the same as the corresponding components of the DBS tuner described above.

Tuner 175 receives the cable feed and separates the received signal into analog or digital channels, depending on whether the tuner is tuned to an analog or digital cable channel. If it is an analog channel, the video content is first decoded by block 177 and then compressed (e.g., MPEG2 or MPEG4) by circuit block 180 prior to downstream transmission. If it is a digital channel, a QAM demodulator circuit 176 is used to demodulate the received signal prior to decryption by block 178. A point of deployment (POD) module 179, which includes the decryption keys for the commercial cable system, is shown coupled to decryption block 178. After decryption, the streaming media content is re-encrypted by block 181 before transmission downstream on the wireless network.

FIG. 14 shows a one-way cable system. As is well-known to persons of ordinary skill in the art, a two-way cable system further includes a modulator for communications back up the cable, as, for example, when a user orders a pay-per-view movie.

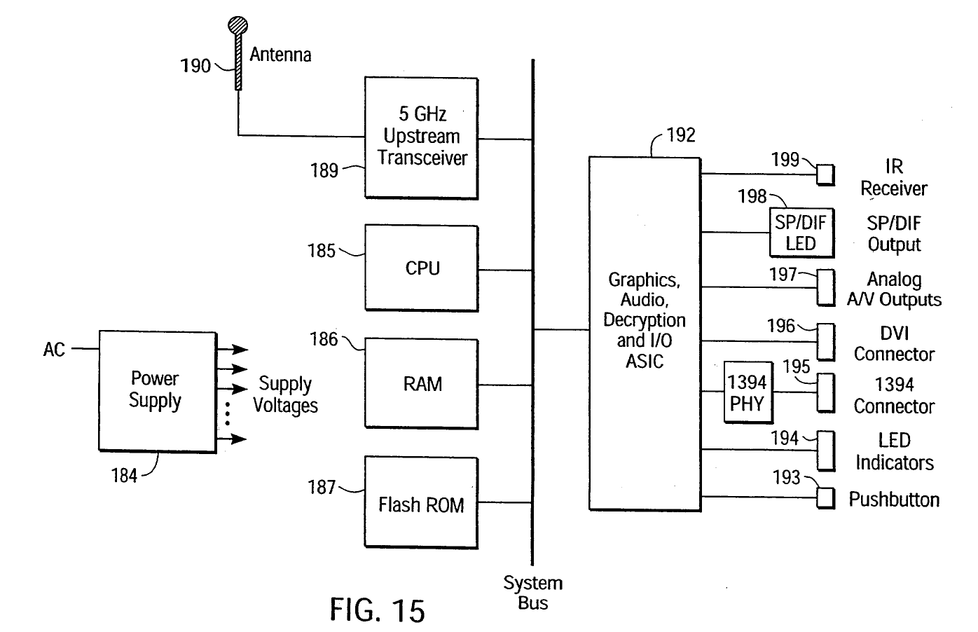

FIG. 15 is a circuit block diagram illustrating the basic architecture of a wireless receiver in accordance with one embodiment of the present invention. Like the repeater, DBS tuner, and cable tuner architectures described previously, the wireless receiver shown in FIG. 15 includes a CPU 185, a RAM 186, and a Flash ROM 187 coupled to a system bus 188. A power supply unit 184 provides a supply voltage to each of the circuit elements shown.

A 5 GHz band upstream transceiver 189 is also shown in FIG. 15 coupled to an antenna 190 and to system bus 188. A single transceiver is all that is required since the receiver of FIG. 23 does not transmit downstream (i.e., it is a leaf in the tree network) and it outputs directly to a display device such as a television. As described earlier, the 5 GHz band offers the advantage of more available channels. Accordingly, I/O ASIC circuitry 192 coupled to bus 188 includes the graphics, audio, decryption, and I/O chips (commercially available from manufacturers such as Broadcom Corporation and ATI Technologies, Inc.) needed to generate the output signals for driving the display device. Accordingly, in addition to elements 193-195 found on the repeater architecture of FIG. 11, I/O ASIC 192 may also provide outputs to a DVI connector 196 (for HDTV), analog audio/video (A/V) outputs 197, an SP/DIF output 198 (an optical signal for surround sound and digital audio), and an infrared receiver port 199 for receiving commands from a remote control unit.

It should be understood that elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Furthermore, although the present invention has been described in conjunction with specific embodiments, numerous modifications and alterations are well within the scope of the present invention. Accordingly, the specification and drawings are to be regarded in an illustrative rather than a restrictive sense.

I claim:

1. A satellite antenna assembly comprising:
a reflector dish;
a low-noise block converter (LNB) to receive a satellite transmission reflected off the reflector dish;
a tuner coupled to the LNB, the tuner including a wireless transceiver operable to transmit video/data contained in the satellite transmission to one or more destination devices in a local area.

2. The satellite antenna assembly of claim 1 wherein the wireless transceiver operates in compliance with IEEE 802.1x specification.

3. The satellite antenna assembly of claim 1 wherein the tuner further includes decryption circuitry to decrypt the video/data contained in the satellite transmission.

4. The satellite antenna assembly of claim 1 wherein the wireless transceiver transmits in the 5 GHZ frequency band.

5. A wireless network comprising:
a satellite antenna assembly that includes:
a reflector dish;
at least one low-noise block converter (LNB) to receive a satellite transmission reflected off the reflector dish; and
a wireless transceiver operable to send/receive video and data transmissions to one or more users in a local area;
a satellite receiver coupled to receive satellite signals from the at least one LNB and output video program signals for viewing on a display device;
an interface unit coupled to provide communication signals to the wireless transceiver, the interface unit being configured for connection to an interactive data network, the one or more users being provided with connectivity to the interactive data network via the wireless transceiver,
wherein the video and data transmissions include the satellite signals.

6. The wireless network of claim 21 wherein the wireless transceiver operates in compliance with IEEE 802.1x specification.

7. The wireless network of claim 21 wherein the satellite signals occupy a first frequency band and the wireless transceiver operates in a second frequency band distinct from the first frequency band.

8. The wireless network of claim 21 wherein the interface unit is further configured to receive video signals from a cable television service provider, and wherein the video and data transmissions include the video signals.

9. The wireless network of claim 21 wherein the communication signals have a frequency range of about 40 MHz to about 1.2 GHz.

10. The wireless network of claim 21 wherein the interface unit and the satellite receiver are integrated into a single unit.

11. The wireless network of claim 21 wherein the interactive data network comprises the Internet.

12. The wireless network of claim 21 further comprising:
a repeater disposed within the local area that extends the video and data transmissions to additional users in a neighboring area.

13. The wireless network of claim 28 further comprising:
an additional repeater disposed within the neighboring area that extends the video and data transmissions to more additional users in a further neighboring area.

14. The wireless network of claim 28 wherein the repeater comprises a second a satellite antenna assembly that includes a second wireless transceiver, the second antenna assembly being disposed within the local area at a distance from the first satellite antenna assembly.

15. The wireless network of claim 23 wherein the second frequency band is the 5 GHz band.

16. A wireless network comprising:
a satellite antenna assembly that includes:
a reflector dish;
at least one low-noise block converter (LNB) positioned opposite the reflector dish; and
a wireless transceiver operable to send/receive video and data transmissions to one or more users in a local area;
a unit coupled to provide communication signals to the wireless transceiver, the unit being configured for connection to an interactive data network, the one or more users being provided with connectivity to the interactive data network via the wireless transceiver; and
a media library apparatus store video programs, the media library apparatus being coupled to the wireless transceiver to provide the one or more users with on-demand access to the video programs.

17. The wireless network of claim 32 wherein the wireless transceiver operates in compliance with IEEE 802.1x specification.

18. The wireless network of claim 33 wherein the one or more users receive the video and data transmissions using a device configured in compliance with IEEE 802.1x specification.

19. The wireless network of claim 32 wherein the satellite signals occupy a first frequency band and the wireless transceiver operates in a second frequency band distinct from the first frequency band.

20. The wireless network of claim 32 wherein the unit is further configured to receive video signals from a cable television service provider, and wherein the video and data transmissions include the video signals.

21. The wireless network of claim 32 wherein the communication signals have a frequency range of about 40 MHz to about 1.2 GHz.

22. The wireless network of claim 32 wherein the interactive data network comprises the Internet.

23. The wireless network of claim 32 further comprising:
a repeater disposed within the local area that extends the video and data transmissions to additional users in a neighboring area.

24. The wireless network of claim 39 wherein the repeater comprises a second a satellite antenna assembly that includes a second wireless transceiver, the second antenna assembly being disposed within the local area at a distance from the first satellite antenna assembly.

25. The wireless network of claim 32 wherein the second frequency band is the 5 GHz band.

26. The wireless network of claim 32 wherein the media library apparatus comprises a redundant array of inexpensive disks (RAID) array.

27. The wireless network of claim 42 wherein the media library apparatus further comprises a transceiver for wireless communication with the wireless transceiver of the satellite antenna assembly.
